(19) United States
(12) Patent Application Publication
(10) Pub. No.: US 2011/0168957 A1
(43) Pub. Date: Jul. 14, 2011

(54) ELECTRICALLY CONDUCTIVE SOLID COMPOSITE MATERIAL, AND METHOD OF OBTAINING SUCH A MATERIAL

(75) Inventors: Antoine Lonjon, Toulouse (FR); Eric Dantras, Toulouse (FR); Philippe Demont, Toulouse (FR); Colette Lacabanne, Toulouse (FR)

(73) Assignee: UNIVERSITE PAUL SABATIER TOULOUSE III, Toulouse Cedex 9 (FR)

(21) Appl. No.: 13/056,325

(22) PCT Filed: Jul. 20, 2009
(86) PCT No.: PCT/FR2009/051442

§ 371 Date: Mar. 24, 2011

(30) Foreign Application Priority Data
Jul. 29, 2008 (FR) 0804309

(51) Int. Cl. H01B 1/22; H01B 1/00; H01B 1/02; B82Y 30/00

(52) U.S. Cl. 252/513; 252/500; 252/512; 252/514; 977/773

(57) ABSTRACT

An electrically conductive solid composite material contains:
a solid matrix of electrically insulating material, and—a load of an electrically conductive material, wherein the charge includes so-called filiform nanoparticles, having: a length, extending along a main elongation direction; two so-called orthogonal dimensions, extending along two directions which are transverse and orthogonal to each other and orthogonal to the main elongation direction, the orthogonal dimensions being less than the length and less than 500 nm; and two so-called form factor ratios between the length and each of the two orthogonal dimensions, the form factor ratios being greater than 50, the filiform nanoparticles being distributed within the volume of the solid matrix with an amount, by volume, of less than 10%, particularly less than 5%.

The invention concerns an electrically conductive solid composite material, and a method of obtaining such a material.

In numerous applications, it is desirable to obtain solid composite materials which, on the one hand, have the advantages of composite materials compared with metals in terms of mechanical properties (in particular, greater lightness for equivalent rigidity or strength), but which, on the other hand, are electrically conductive, meaning that they have an electrical conductivity greater than 1 S·m⁻¹, typically of the order of 10² S·m⁻¹. This is the case, in particular, for implementation of supporting or structural parts (underframes, plates, etc.), or of materials (adhesives, joints) for assembling structural parts, or for coating (painting) parts of vehicles, and more particularly of aircraft and motor vehicles.

In other applications, it is desirable to obtain such solid composite materials which are also thermally conductive, meaning that they have a thermal conductivity greater than 10⁻⁴ W/mK. This is the case, in particular, for implementation of parts which are likely to be heated by Joule effect, in particular to deice them.

The invention also extends to a compressed composite material of great viscosity, in particular adhesives, having such a thermal conductivity and/or such an electrical conductivity, but remaining capable of pouring.

It has already been proposed that charges of micrometric or nanometric particles of an electrically conductive material, in particular nanotubes of carbon, should be incorporated into composite materials (cf. WO 01/87193). Nevertheless, the problem that is raised is that of obtaining sufficient conductivity without degrading the mechanical properties of the composite material. In fact, the best conductivities obtained are of the order of 10⁻¹ S·m⁻¹ with carbon nanotubes with very low charge rates (about 1% by volume), without significant degradation of the mechanical properties. On the other hand, the maximum conductivities are obtained by using a quantity per volume greater than 25%, typically of the order of 50%, which modifies considerably the mechanical properties of the obtained composite material.

The invention is thus aimed at proposing a solid composite material having, simultaneously, mechanical properties comparable to those of insulating composite materials, but an electrical conductivity greater than 1 S·m⁻¹.

The invention is also aimed at proposing such a composite material which keeps mechanical properties relative to insulating composite materials, but also has increased thermal conductivity, in particular by a factor of 20000, relative to insulating composite materials.

More particularly, the invention is aimed at proposing a solid composite material having a solid matrix (homogeneous or composite) of an electrically insulating material, and an electrical conductivity greater than 1 S·m⁻¹, the final mechanical properties of the solid composite material according to the invention being at least 90% of those of the solid matrix.

The invention is also aimed at proposing a composite material having an electrical conductivity greater than 1 S·m⁻¹, but in which the excess mass load associated with the electrically conductive constituent in the composite material does not exceed 30%.

The invention is also aimed at proposing a method of obtaining such a material according to the invention which is simple and inexpensive, can be implemented quickly and respects the environment, making it possible to implement parts of any shape, with material compositions which can also vary.

To do this, the invention concerns an electrically conductive solid composite material comprising:
a solid matrix of an electrically insulating material,
a charge of an electrically conductive material,
   wherein said charge comprises nanoparticles, called filiform nanoparticles, having:
a length, which extends according to a principal elongation direction,
two dimensions, called orthogonal dimensions, which extend according to two directions which are transverse and orthogonal to each other and orthogonal to said principal elongation direction, said orthogonal dimensions being less than said length and less than 500 nm, and
two ratios, called form factors, between said length and each of the two orthogonal dimensions, said form factors being greater than 50,
   said filiform nanoparticles being distributed in the volume of the solid matrix with a quantity by volume less than 10%, in particular less than 5%.

More particularly, a material according to the invention advantageously has at least one of the following characteristics:
the two orthogonal dimensions of the filiform nanoparticles are between 50 nm and 300 nm—in particular of the order of 200 nm,
the filiform nanoparticles have a length greater than 1 μm, in particular between 30 μm and 300 μm, in particular of the order of 50 μm,
the two orthogonal dimensions of the filiform nanoparticles are the diameter of the straight transverse section of the filiform nanoparticles,
the filiform nanoparticles have two form factors greater than 50—in particular of the order of 250,
the filiform nanoparticles are formed of a material chosen from the group consisting of gold, silver, nickel, cobalt, copper and their alloys, in the non-oxidized state,
the filiform nanoparticles are formed of a metallic non-oxidized material,
it includes a quantity of filiform nanoparticles between 0.5% and 5% by volume,
the solid matrix is formed of a polymer material,
the solid matrix includes at least one solid polymer material, in particular chosen from thermoplastic materials, crosslinkable materials, in particular thermosetting materials.

Throughout the text:
a “filiform nanoparticle” in the meaning of the invention is, in particular, a nanorod or nanowire. In particular, the two orthogonal dimensions of a filiform nanoparticle are the diameter of its straight transverse section. A filiform nanoparticle can also be a ribbon, in which the two orthogonal dimensions of the filiform nanoparticle according to the invention are its width (first orthogonal dimension) and its thickness (second orthogonal dimension).
the term “form factor” is the ratio between the length of a filiform nanoparticle and one of the two orthogonal dimensions of said filiform nanoparticle. As an example, a form factor equal to 200 for a filiform nanoparticle in the overall form of a cylinder of revolution means that its length is approximately equal to 200 times its mean diameter. In any case, a filiform nanoparticle is overall in elongated form, in which the ratios of its greatest dimension (its length) to each of the two orthogonal dimensions are greater than 50.

In particular, the metal forming the filiform nanoparticles is chosen from the group formed of non-oxidizable metals and metals which are liable to form, by oxidation, a stabilized layer of oxidized metal which extends on the surface of the filiform nanoparticles and is suitable for preserving from oxidation the underlying non-oxidized solid metal. Thus a metal which is liable to form, by oxidation, a surface layer of limited thickness while preserving the underlying metal from oxidation is suitable for forming a composite material of high electrical conductivity after elimination of the oxidized surface layer. Such metals are, in particular, metals of which the superficial oxidation causes the formation of a superficial layer, called the passivating layer, which protects from oxidation.

Advantageously and according to the invention, the material has an electrical conductivity greater than 1 S·m⁻¹, in particular of the order of 10² S·m⁻¹. In particular, such a material according to the invention includes a quantity of filiform nanoparticles of the order of 5% by volume, and an electrical conductivity of the order of 10² S·m⁻¹. More particularly and according to the invention, such a material includes a quantity of filiform nanoparticles of the order of 5% by volume, an electrical conductivity of the order of 10² S·m⁻¹, and final mechanical properties which are approximately kept (in particular to over 90%) relative to the solid matrix.

The invention extends to a method of obtaining a material according to the invention. The invention thus concerns a method of obtaining a conductive solid composite material, wherein filiform nanoparticles of an electrically conductive material are dispersed, said nanoparticles having a length, which extends according to a principal elongation direction, two dimensions, called orthogonal dimensions, which extend according to two directions which are transverse and orthogonal to each other and orthogonal to said principal elongation direction, said orthogonal dimensions being less than said length and less than 500 nm, and two ratios, called form factors, between the length and each of the two orthogonal dimensions, said form factors being greater than 50, in a liquid composition which is the precursor of a solid matrix of electrically insulating material, in such a way as to obtain a quantity by volume of filiform nanoparticles in the composite material of less than 10%, in particular less than 5%.

Advantageously and according to the invention, filiform nanoparticles of which the two form factors are greater than 50, particularly between 50 and 5000, more particularly between 100 and 1000, particularly and advantageously of the order of 250, are used.

Advantageously and according to the invention, filiform nanoparticles are dispersed in a liquid solvent, this dispersion is mixed into the precursor liquid composition, and the liquid solvent is eliminated. Said liquid solvent is preferably chosen from the solvents which are not liable to oxidize the filiform nanoparticles, or are liable to oxidize them only partially and in a limited manner.

Additionally, advantageously and according to the invention, the solid matrix comprising at least one polymer material, the precursor liquid composition is a solution of said polymer material in a liquid solvent chosen from the solvent of the dispersion of filiform nanoparticles and the solvents which can be mixed with the solvent of the dispersion of filiform nanoparticles. The dispersion of filiform nanoparticles can advantageously be incorporated into said precursor liquid composition in the course of a manufacture stage of the solid matrix.

Advantageously and according to the invention, the solid matrix comprising at least one thermoplastic material, the precursor liquid composition is formed from the solid matrix in the molten state. As a variant, advantageously and according to the invention, the solid matrix comprising at least one thermosetting material, the precursor liquid composition is formed of at least one liquid composition which enters into the composition of the thermosetting material.

Advantageously and according to the invention, the solid matrix comprising at least one crosslinked, in particular thermally crosslinked, material, the precursor liquid composition is formed of at least one liquid composition which enters into the composition of the crosslinkable, in particular thermally crosslinkable, material.

Additionally, advantageously and according to the invention, the dispersion of filiform nanoparticles in the precursor liquid composition is subjected to ultrasound.

Additionally, advantageously, in a method according to the invention, filiform nanoparticles according to at least one of the characteristics mentioned above are used.

Advantageously and according to the invention, a quantity of filiform nanoparticles between 0.5% and 5% by volume is used. A quantity of metallic filiform nanoparticles approximately between 0.5% and 5.0% is used, said quantity being suitable for avoiding the increase of the mass of the composite material while keeping, on the one hand, a high value of electrical conductivity, in particular greater than 1 S·m⁻¹, and on the other hand the mechanical properties of the initial polymer material.

The invention makes it possible, for the first time, to obtain a solid composite material with mechanical properties corresponding at least approximately to those of a (homogeneous or composite) insulating solid matrix with high electrical conductivity, greater than 1 S·m⁻¹, typically of the order of 10² S·m⁻¹. A material according to the invention can thus advantageously replace the traditionally used metallic materials (steels, light alloys, etc.), in particular for construction of supporting and/or structural parts in vehicles, in particular aircraft, or even in buildings.

A composite material according to the invention can also be used as an adhesive or joint, to implement materials of glued assemblies. In particular, a composite material according to the invention is suitable for making it possible to implement a conductive composite adhesive.

A composite material according to the invention can also be used as a composite coating, to implement composite paints of high electrical conductivity per unit volume, in particular greater than 1 S·m⁻¹, typically of the order of 10² S·m⁻¹, and of surface resistance (in standardized units according to standards ASTM D257.99 and ESDSTM 11.11.2001) less than 10000 Ω/square.

Advantageously, a composite material according to the invention is suitable for making it possible to implement heating parts, in particular by Joule effect, one of the applications of which is, as a non-limiting example, surface deicing.

Other objects, characteristics and advantages of the invention will appear on reading the following description, which refers to the attached figures, and the non-limiting examples which follow, in which:

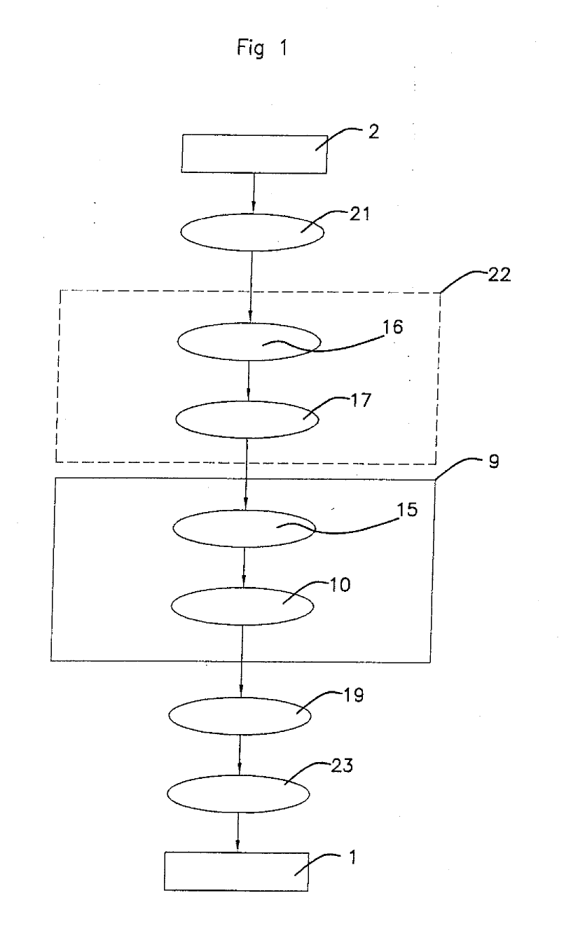

FIG. 1 is a block diagram describing a method of manufacturing metallic filiform nanoparticles,

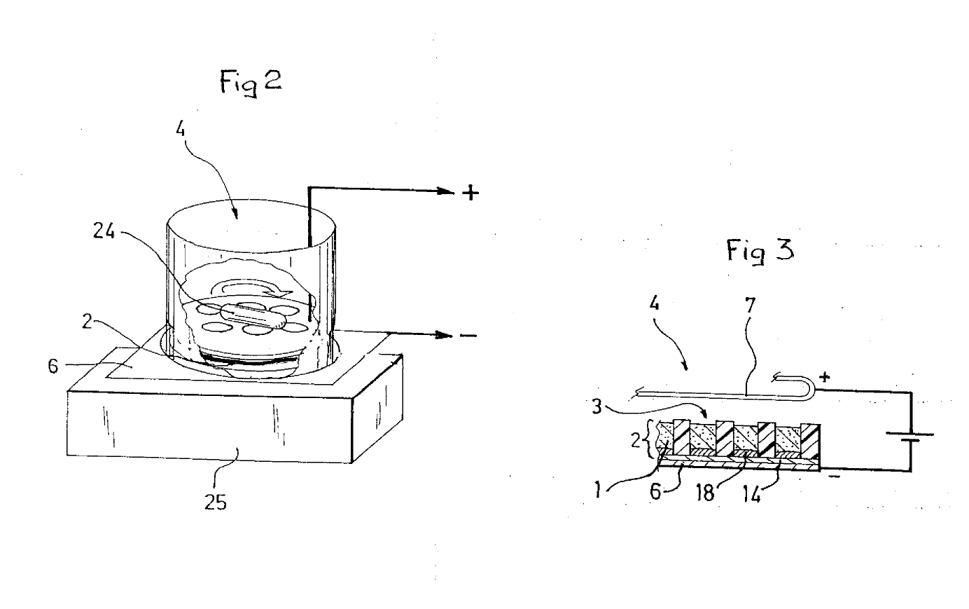

FIG. 2 is a perspective diagram of a device which is used in a method of manufacturing metallic filiform nanoparticles,

FIG. 3 is a sectional view of a detail of an electroplating device according to the invention,

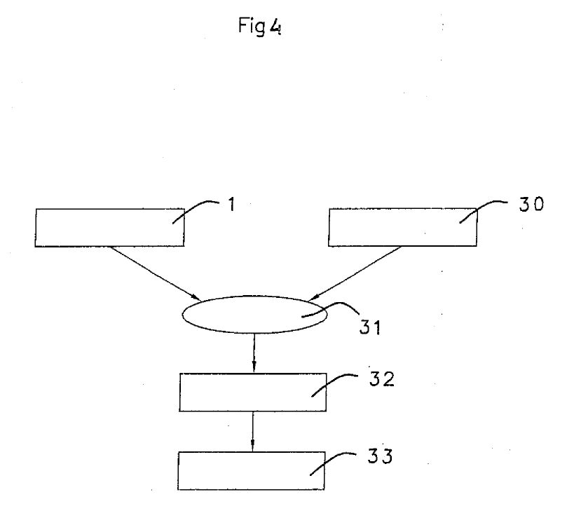

FIG. 4 is a general flowchart of a method according to the invention.

In a method of manufacturing metallic filiform nanoparticles 1 according to the invention, shown in FIG. 1, a solid membrane 2, having parallel channels 3 crossing and opening onto the two principal faces of said membrane 2, is used. For example, the membrane 2 is a porous layer obtained by anodization of an aluminum substrate, for example of thickness approximately of the order of 50 μm and having pores of which the mean diameter of the parallel straight section to the principal faces of the porous layer is, for example, of the order of 200 nm. The membrane 2 is, for example, a filtration membrane of alumina (Porous Anodised Alumina, Whatman, Ref. 6809-5022 and 6809-5002). In a method according to the invention, the thickness of the membrane 2 and its mean porosity are suitable for making it possible to manufacture metallic filiform nanoparticles 1 having a dimension less than 500 nm and a high form factor, in particular greater than 50.

A step 21 of applying a layer 14 of metallic silver on one of the principal faces of said membrane 2 is implemented, said layer 14 being suitable for closing the channels 3 on the cathode face of the membrane 2 and for forming an electrically conductive contact between a conductive metal plate 6, e.g. of copper or silver, forming the cathode of an electroplating device, and the membrane 2. This application is implemented by all appropriate means, in particular by cathode sputtering of a silver substrate on the cathode face of the membrane 2.

An electrically conductive connection is formed between the plate 6, forming the cathode of the electroplating device, and the cathode face of the membrane 2, by contact by the silver layer 14 of the membrane 2 with the plate 6 forming the cathode. This electrically conductive connection is implemented by sealing the membrane 2 and the plate 6 by mechanical and/or adhesive means, in particular by silver lacquer.

An anode 7 is arranged facing the face of the membrane 2, opposite the cathode. The anode 7, cathode 6 and membrane 2 are submerged in an electrolytic bath 4. The anode 7 is in the form of a solid metallic wire, in particular of a wire consisting of solid metal to be electroplated, and the diameter of which is of the order of 1 mm. However, in a device for implementing a method according to the invention, the anode 7 can be in the form of a ribbon, a grid or a plate. The anode 7 has the same chemical composition as the metal forming the cations of the electroplating bath. The anode 7 is placed parallel to the accessible surface of the membrane 2, and at a distance of the order of 1 cm from the accessible surface of the solid membrane 2.

In this device, shown in FIG. 2, the anode 7 is connected to the positive terminal of a direct current generator, and the cathode 6 is connected to the negative terminal of this generator.

In this configuration, the thus formed electroplating device, shown in FIG. 2, is suitable for making it possible to establish a stable current during the electroplating, and to form filiform nanoparticles 1 of high form factor and great conductivity in the channels 3 of the membrane 2.

The electroplating device also includes means of agitating and homogenizing the electroplating bath 4. These agitating and homogenizing means include, for example, a magnetic agitating element 24 which is placed in the electroplating bath in such a way that this element does not come into contact with either the solid membrane 2 or the metallic wire forming the anode 7. Additionally, the electroplating bath 4 is maintained at a predetermined temperature less than 80°, in particular between 40° C. and 60° C., in particular of the order of 50° C. for electroplating gold, by heating the electroplating bath 4 by a heating element 25 which is arranged under the plate 6 forming the cathode.

In a preliminary electroplating step 16, a growth initiation layer 18 is formed by carrying out electroplating with an electroplating bath formed of a solution containing cationic types of nickel, in particular a solution, called the Watts solution, containing Ni²⁺ cations. This initial electroplating of the metal is carried out at the bottom of the channels 3 of the membrane 2 from the silver layer 14 which encloses them. This electroplating is carried out in such a way that the thickness of the obtained growth initiation layer 18 is, for example, of the order of 3 μm. Such a nickel layer is obtained at the end of the preliminary electroplating step 16 of a duration of electroplating approximately of the order of 5 min, for a mean electric current value of the order of 80 mA.

In a subsequent step 17 of electroplating the metallic filiform nanoparticles 1, the previous electrolytic bath is replaced by a bath including the metallic type(s) of the metallic filiform nanoparticles 1 to be prepared, and electroplating of this metal is carried out, in particular with a voltage between the cathode 6 and the anode 7 of the electroplating device, e.g. for electroplating gold, of a value less than 1 V, in particular of the order of 0.7 V. In these conditions, the initial amperage of the current in the electroplating device is approximately of the order of 3.5 mA. As the metal of the metallic filiform nanoparticles 1 is deposited, the amperage of the current decreases until it reaches a value of the order of 0.9 mA. Thus a composite material in the form of a layer of alumina, the pores of which form a molding of metallic filiform nanoparticles 1, is formed. The formed filiform nanoparticles 1 have a metallic structure which is close to the structure of the solid metal, and having the conductive properties of the solid metal. The thus obtained metallic filiform nanoparticles 1 have a high form factor. The thus obtained metallic filiform nanoparticles 1 have a length corresponding to that of the channels, e.g. greater than 40 μm, in particular of the order of 50 μm.

In a method according to the invention, shown in FIG. 1, the membrane 2 and the plate 6 forming the cathode of the electroplating device are then separated, so as to free the principal face of said membrane 2, which has the silver layer 14.

During the subsequent dissolution processing 9, a step 15 of acid etching of the thus exposed silver layer 14, and of the growth initiation layer 18 in the form of nickel, is carried out. This acid etching step 15 is carried out by plugging the surface of the membrane 2 with cotton impregnated with a solution of nitric acid at a mass concentration of 68%. This acid etching step 15 can also be carried out according to any appropriate method which is suitable for making it possible to dissolve the silver and nickel without significantly dissolving the alumina of the solid membrane 2. Thus the silver layer 14 and at least part of the thickness of the nickel layer 18 are eliminated, while preserving the metallic filiform nanoparticles 1 from said acid etching 15.

A step 10 of alkaline etching and dissolving the membrane 2 comprising the metallic filiform nanoparticles 1 is then carried out, in suitable conditions for making alkaline etching and solubilization of the alumina of the solid membrane 2 in a dissolving alkaline bath possible, while preserving the metal of the metallic filiform nanoparticles 1.

For example, the membrane 2, including the metallic filiform nanoparticles 1, is immersed in the bath formed of an aqueous alkaline solution of sodium hydroxide or potassium hydroxide, at ambient temperature, in particular at a temperature between 20° C. and 25° C. A concentration of alkaline salt in the solution between 0.1 g/L and the saturation concentration of the solution is chosen, in particular a concentration approximately of the order of 48 g/L. With a processing duration of 15 min in a solution of sodium hydroxide at 48 g/L, the alumina of the membrane 2 is completely solubilized in the aqueous solution of sodium hydroxide, and the solid metallic filiform nanoparticles 1 are released in suspension in said aqueous solution of sodium hydroxide.

It is particularly advantageous, in a method according to the invention, to separate on the one hand the aqueous alkaline solution containing the excess of sodium hydroxide and the solubilized alumina, and on the other hand the metallic filiform nanoparticles 1, to make later use of the metallic filiform nanoparticles 1 possible. This separation 19 is carried out by filtering the metallic filiform nanoparticles 1 and the aqueous alkaline solution using a membrane of polyamide having a mean porosity of the order of 0.2 μm. A WHATMAN nylon membrane (Ref. 7402-004), on which the metallic filiform nanoparticles 1 are retained, is used. This step of separation 19 by filtration is implemented by all appropriate means, e.g. filtration means in vacuum or at atmospheric pressure. Next, on the polyamide membrane, a step of washing the metallic filiform nanoparticles 1 with a suitable quantity of distilled water to make it possible to eliminate the aqueous alkaline solution and solubilized alumina is carried out. It is of course preferable not to leave the metallic filiform nanoparticles 1 in direct contact with the oxygen of the air, so as to minimize the risks of oxidizing the metallic filiform nanoparticles 1.

To weigh the mass of the metallic filiform nanoparticles 1 which are produced during a method of manufacture according to the invention, the metallic filiform nanoparticles 1 are rinsed with a volatile solvent, in particular a solvent chosen from acetone and ethanol. The obtained metallic filiform nanoparticles 1 are then dried by heating at a temperature above the boiling point of the volatile solvent, in particular at 60° C. for acetone.

It is preferable to keep the metallic filiform nanoparticles 1 protected from the air in a usual solvent, e.g. chosen from the group formed of water, acetone, toluene. The metallic filiform nanoparticles 1 are dispersed in the solvent so as to avoid the formation of aggregates of metallic filiform nanoparticles 1. Advantageously, the metallic filiform nanoparticles 1 are dispersed in the solvent by a process 23 of suspending the filiform nanoparticles 1 in the liquid medium in an ultrasound bath of frequency approximately of the order of 20 kHz for a power of the order of 500 W.

In a method of manufacturing an electrically conductive solid composite material 33 according to the invention, shown in FIG. 4, metallic filiform nanoparticles 1 in the non-oxidized state, having a dimension less than 500 nm and a high form factor—in particular greater than 50—are dispersed in a liquid composition 30 which is the precursor of the solid matrix. The liquid composition 30 is chosen from the group formed of thermoplastic electrical insulating polymers and thermosetting electrical insulating polymers. For example, a thermoplastic electrical insulator from the group formed by polyamide and the copolymers of vinylidene polyfluoride (PVDF) and trifluoroethylene (TRFE) is chosen. A PVDF-TRFE copolymer advantageously has an intrinsic conductivity of the order of 10⁻¹² S·m⁻¹. This dispersion is achieved by mixing 31 on the one hand a suspension of metallic filiform nanoparticles 1 in the non-oxidized state into a liquid medium formed by a solvent, and on the other hand a liquid composition obtained by solubilizing an electrical insulating polymer into the same solvent. For example, a quantity of a PVDF-TRFE copolymer is dissolved in a quantity of acetone, and a quantity of the suspension of filiform nanoparticles 1 in acetone is added to it. This mixture is carried out in such a way that the proportion by volume of metallic filiform nanoparticles 1 and copolymer is less than 10%, in particular close to 5%. The mixture of filiform nanoparticles 1 and the composition 30 of PVDF-TRFE in acetone is homogenized. It is possible to improve the dispersion of solid filiform nanoparticles 1 in the liquid mixture by processing the suspension with ultrasound.

Subsequently, a step 32 of eliminating the solvent is carried out. This step of eliminating the solvent is carried out by all appropriate means, in particular by evaporating the solvent at atmospheric pressure, in particular by heat, or by evaporation under reduced pressure. A composite formed of a dispersion of filiform nanoparticles 1 in a solid matrix of PVDF-TRFE is obtained.

A step 33 of shaping the composite solid material according to the invention is then carried out. This shaping is carried out by all appropriate means, and in particular hot pressing and/or hot molding.

In a method according to the invention, metallic filiform nanoparticles 1 which are liable to be obtained by a manufacture method shown in FIG. 1 are used. Such metallic filiform nanoparticles 1, also called nanowires, of form factor greater than 50, are prepared by a method of electroplating silver in the channels of a solid porous membrane, as described in examples 1 to 5.

### EXAMPLE 1

### Preparation of Gold Nanowires

A filtration membrane of alumina is processed by cathode sputtering (Porous Anodised Alumina, Whatman, Ref. 6809-5022 or 6809-5002) with silver, so as to deposit a film of silver covering the surface of the filtration membrane. The face of the solid membrane coated with silver (conductive cathode surface) is applied to the plate forming the cathode of an electroplating device, so as to form an electrically conductive contact between the plate forming the cathode and the silvered surface of the filtration membrane. Then, in the preliminary electroplating step, the first growth initiation layer is deposited from an electrolytic Watts solution containing Ni²⁺ ions. The amperage of the current established between the anode and the cathode is controlled so that the value of the latter is maintained at 80 mA for 5 min at ambient temperature. Thus, on the bottom of the open pores of the solid membrane, a deposit of metallic nickel of thickness approximately of the order of 3 μm is obtained. The channels of the solid membrane are rinsed so as to extract from the channels the metallic cations of the electroplating bath of the preliminary electroplating step.

For the step of electroplating the gold nanowires, the nickel anode of the electroplating device is replaced by a gold anode, and the Watts solution is replaced by a complex gold solution with thisulfate-thiosulfite anions without cyanide. Electroplating is carried out at 0.7 V and keeping the temperature of the electrolytic solution at a value close to 50° C., with magnetic agitation. In these conditions, the initial amperage of the electric current is approximately of the order of 3.5 mA, and decreases during depositing to a value of the order of 0.9 mA. The cathode face of the solid membrane is treated by immersing the solid membrane in an aqueous solution of nitric acid at a mass concentration of 680 g/L. The solid membrane containing the metallic nanoparticles is then immersed in an aqueous solution of soda at a concentration of 48 g/L. At the end of 15 min of treatment, the gold nanowires are released into the soda solution. Then, the released gold nanowires and the alkaline solution are separated by filtration. The gold nanowires are washed with acetone. It is preferable to store the thus prepared gold nanowires in the same solvent. 25 mg of gold nanowires are obtained per cm² of solid membrane. These gold nanowires have a mean diameter of the order of 200 nm and a length of the order of 50 μm, for a form factor approximately close to 250.

### EXAMPLE 2

### Preparation of Nickel Nanowires

As described in example 1, a filtration membrane of alumina, having a silver film on its cathode face and a nickel growth initiation layer, is prepared.

For the step of electroplating nickel nanowires, the nickel anode of the electroplating device and the Watts solution are kept. Electroplating is carried out at a voltage between 3 V and 4 V, in particular of the order of 3 V, and keeping the temperature of the electrolytic solution at a value close to ambient temperature, and without agitating the electrolytic solution. In these conditions, nickel nanowires of length approximately of the order of 50 μm are obtained in 40 min with an initial amperage of electric current between the anode and the cathode of the order of 180 mA, in 60 min with an initial amperage of electric current between the anode and the cathode of the order of 98 mA, in 90 min with an initial amperage of electric current between the anode and the cathode of the order of 65 mA.

In the same way as in example 1, the silver and surface nickel of the solid membrane are eliminated, and the nickel nanowires are released by alkaline treatment. 12 mg of nickel nanowires are obtained per cm² of solid membrane. These nickel nanowires have a mean diameter of the order of 200 nm and a length of the order of 50 μm for a form factor close to 250.

### EXAMPLE 3

### Preparation of Cobalt Nanowires

As described in example 1, a filtration membrane of alumina, having a silver film on its cathode face and a nickel growth initiation layer, is prepared.

For the step of electroplating cobalt nanowires, a cobalt anode and an aqueous solution of cobalt sulfate are used (Co²⁺). Since cobalt has an electrochemical couple close to that of nickel, electroplating is carried out at a voltage between 3 V and 4 V, and keeping the temperature of the electrolytic solution at a value close to ambient temperature, and without agitating the electrolytic solution. In these conditions, cobalt nanowires of length approximately of the order of 50 μm are obtained in 40 min with an initial amperage of electric current between the anode and the cathode of the order of 180 mA, in 60 min with an initial amperage of electric current of the order of 98 mA, in 90 min with an initial amperage of electric current of the order of 65 mA.

In the same way as in example 1, the silver and surface nickel of the solid membrane are eliminated, and the cobalt nanowires are released by alkaline treatment.

### EXAMPLE 4

### Preparation of Silver Nanowires

As described in example 1, a filtration membrane of alumina, having a silver film on its cathode face and a nickel growth initiation layer, is prepared.

For the step of electroplating silver nanowires, a silver anode and an aqueous solution of silver sulfite are used. Electroplating is carried out at a voltage close to 0.25 V and keeping the temperature of the electrolytic solution at a value close to 30° C., with agitation of the electrolytic solution. In these conditions, silver nanowires of length approximately of the order of 50 μm are obtained in 180 min with an initial amperage of electric current between the anode and the cathode of the order of 9 mA.

In the same way as in example 1, the silver and surface nickel of the solid membrane are eliminated, and the silver nanowires are released by alkaline treatment.

### EXAMPLE 5

### Preparation of Copper Nanowires

As described in example 1, a filtration membrane of alumina, having a silver film on its cathode face and a nickel growth initiation layer, is prepared.

For the step of electroplating copper nanowires, a copper anode and an aqueous solution of copper sulfate are used (Cu²⁺). Electroplating is carried out at a voltage close to 0.5 V, in particular 0.6 V, and keeping the temperature of the electrolytic solution to a value close to ambient temperature, and without agitating the electrolytic solution. In these conditions, copper nanoparticles of length approximately of the order of 50 μm are obtained in 30 min with an initial amperage of electric current between the anode and the cathode of the order of 100 mA.

In the same way as in example 1, the silver and surface nickel of the solid membrane are eliminated, and the copper nanowires are released by alkaline treatment.

### EXAMPLE 6

### Preparation of a Conductive Composite Material Based on a Thermoplastic Matrix (PVDF-TRFE)

250 mg of gold nanoparticles (gold nanowires obtained according to example 1) are dispersed in 15 mL of acetone, and the obtained suspension is subjected to ultrasound treatment in an ultrasound bath of frequency approximately of the order of 20 kHz, for a dispersed power of the order of 500 W. Also, 443 mg of PVDF-TRFE are solubilized in 10 mL of acetone, and the suspension of gold nanowires is added to the PVDF-TRFE solution. This mixture is homogenized by ultrasound treatment at a frequency of the order of 20 kHz, for a dispersed power of the order of 500 W, so as to preserve the structure of the nanowires. The acetone is eliminated from the mixture by evaporating the acetone at reduced pressure in a rotating evaporator, and the obtained composite material is pressed to obtain a polymer film 150 μm thick. The rate of charge of the gold nanowires in the thus obtained composite material is close to 5% by volume. Such a charge of 5% by volume of gold nanowires in the composite material corresponds to a 30% increase of the mass of the composite material. The conductivity of the composite material is 10² S·m⁻¹. Additionally, and particularly advantageously, the percolation threshold of such a composite material, below which the material loses its conductivity, is of the order of 2% (by volume).

For comparison, to achieve such conductivity of 10² S·m⁻¹ with a composition of micrometric particles of form factor less than 50 in a PVDF-TRFE copolymer, the rate of charge by volume would have to be at least 28%, and the increase of the mass of composite material would be of the order of 70% and significantly affect the mechanical properties of the final composite.

### EXAMPLE 7

### Preparation of a Conductive Composite Material Based on a Thermosetting Matrix (Epoxy Resin)

250 mg of silver nanoparticles (silver nanowires) are dispersed in 15 mL of acetone, and the obtained suspension is subjected to ultrasound treatment in an ultrasound bath of frequency approximately of the order of 20 kHz, for a dispersed power of the order of 500 W. Also, 515 mg of epoxy resin of DGEBA type (diglycidic ether of bisphenol-A) with a hardener in the form of an amine are solubilized in 10 mL of acetone, and the suspension of silver nanowires is added to the epoxy resin solution. This mixture is homogenized by mechanical agitation, then by ultrasound treatment at a frequency of the order of 20 kHz, for a dispersed power of the order of 500 W, so as to preserve the structure of the nanowires. The acetone is eliminated from the mixture by evaporating the acetone at reduced pressure in a rotating evaporator. The homogeneous suspension of silver nanowires in the epoxy matrix is then degassed at a pressure below atmospheric pressure, and the resin and hardener are polymerized at ambient temperature.

The rate of charge of the silver nanowires in the thus obtained composite material is close to 5% by volume. Such a charge of 5% by volume of silver nanowires in the composite material corresponds to a 33% increase of the mass of the composite material. The conductivity of the composite material is 10² S·m⁻¹. Additionally, and particularly advantageously, the percolation threshold of such a composite material, below which the material is not electrically conductive, is of the order of 2% (by volume).

For comparison, to achieve such conductivity of 10² S·m⁻¹ with a composition of micrometric particles of form factor less than 50 in an epoxy resin of DGEBA type, the rate of charge by volume would have to be at least 20%, and the increase of the mass of composite material would be of the order of 70%.

### EXAMPLE 8

### Preparation of a Conductive Composite Film Based on a Thermoplastic Matrix (PEEK—Polyetheretherketone)

1 g of silver nanoparticles (silver nanowires), the manufacture of which is described in example 4, and 2.35 g of PEEK powder are placed in the feed hopper of a two-screw extruder which is brought to 400° C. The extruded composite is shaped in a press at 400° C., so as to form a film 150 μm thick, and is then cooled to ambient temperature. The rate of charge of the silver nanowires in the thus obtained composite film is close to 5% by volume and of the order of 30% by mass. The electrical conductivity of the composite film is 10² S·m⁻¹.

### EXAMPLE 9

### Preparation of a Conductive Composite Coating Based on a Polyurethane Matrix

250 mg of silver nanoparticles (silver nanowires), the manufacture of which is described in example 4, are dispersed in a composition of polyols, and the obtained suspension is subjected to ultrasound treatment in an ultrasound bath of frequency approximately of the order of 20 kHz, for a dispersed power of the order of 500 W. The hardener of isocynate type is then added to the suspension. The sum of the mass of the polyol and the mass of the hardener is 488 mg. The use of the composite coating is identical to that of the polyurethane coating which does not contain silver nanowires. The precursor suspension of the composite coating can be applied, like a paint, by brush or spraying.

The rate of charge of the silver nanowires in the thus obtained composite coating is close to 5% by volume and of the order of 34% by mass. The conductivity of the composite coating is 10² S·m, and its surface resistivity is less than 10 Ω/square.

1-20. (canceled)

21. An electrically conductive solid composite material comprising:
a solid matrix of an electrically insulating material,
a charge of an electrically conductive material,
wherein said charge comprises nanoparticles, called filiform nanoparticles, having:
a length, which extends according to a principal elongation direction,
two dimensions, called orthogonal dimensions, which extend according to two directions which are transverse and orthogonal to each other and orthogonal to said principal elongation direction, said orthogonal dimensions being less than said length and less than 500 nm, and
two ratios, called form factors, between said length and each of the two orthogonal dimensions, said form factors being greater than 50,
said filiform nanoparticles being distributed in the volume of the solid matrix with a quantity by volume less than 10%, in particular less than 5%.

22. A material as claimed in claim 21, wherein the two orthogonal dimensions of the filiform nanoparticles are between 50 nm and 300 nm—in particular of the order of 200 nm.

23. A material as claimed in claim 21, wherein the filiform nanoparticles have two form factors greater than 50—in particular of the order of 250.

24. A material as claimed in claim 21, wherein the filiform nanoparticles have a length greater than 1 μm, in particular between 30 μm and 300 μm, in particular of the order of 50 μm.

25. A material as claimed in claim 21, wherein the filiform nanoparticles are formed of a metal chosen from the group formed of gold, silver, nickel, cobalt, copper and their alloys, in the non-oxidized state.

26. A material as claimed in claim 21, including a quantity of filiform nanoparticles between 0.5% and 5% by volume.

27. A material as claimed in claim 21, wherein the solid matrix includes at least one polymer material.

28. A material as claimed in claim 21, having an electrical conductivity greater than 1 S·m⁻¹, in particular of the order of 10² S·m⁻¹.

29. A method of obtaining a solid composite conductive material, wherein a dispersion of filiform nanoparticles of electrically conductive material is carried out, having:
a length, which extends according to a principal elongation direction,
two dimensions, called orthogonal dimensions, which extend according to two directions which are transverse and orthogonal to each other and orthogonal to said principal elongation direction, said orthogonal dimensions being less than said length and less than 500 nm, and
two ratios, called form factors, between the length and each of the two orthogonal dimensions, said form factors being greater than 50,
in a liquid composition which is the precursor of a solid matrix of electrically insulating material, in such a way as to obtain a quantity by volume of filiform nanoparticles in the composite material of less than 10%.

30. A method as claimed in claim 29, wherein
filiform nanoparticles are dispersed in a liquid solvent,
this dispersion is mixed into the precursor liquid composition,
the liquid solvent is eliminated.

31. A method as claimed in claim 30, wherein, the solid matrix comprising at least one polymer material, the precursor liquid composition is a solution of said polymer material in a liquid solvent chosen from the solvent of the dispersion of filiform nanoparticles and the solvents which can be mixed with the solvent of the dispersion of filiform nanoparticles.

32. A method as claimed in claim 29, wherein, the solid matrix comprising at least one thermoplastic material, the precursor liquid composition is formed from the solid matrix in the molten state.

33. A method as claimed in claim 29, wherein, the solid matrix comprising at least one thermosetting material, the precursor liquid composition is formed of at least one liquid composition which enters into the composition of the thermosetting material.

34. A method as claimed in claim 29, wherein, the solid matrix comprising at least one crosslinked material, the precursor liquid composition is formed of at least one liquid composition which enters into the composition of the crosslinkable material.

35. A method as claimed in claim 29, wherein the dispersion of filiform nanoparticles in the precursor liquid composition is subjected to ultrasound.

36. A method as claimed in claim 29, wherein filiform nanoparticles of which the two orthogonal dimensions are between 50 nm and 300 nm—in particular of the order of 200 nm—are used.

37. A method as claimed in claim 29, wherein filiform nanoparticles of which the two form factors are greater than 50—in particular of the order of 250—are used.

38. A method as claimed in claim 29, wherein the filiform nanoparticles have a length, extending according to a principal elongation direction, greater than 1 μm, in particular between 30 μm and 300 μm, in particular of the order of 50 μm.

39. A method as claimed in claim 29, wherein filiform nanoparticles formed of a material chosen from the group consisting of gold, silver, nickel, cobalt, copper and their alloys, in the non-oxidized state, are used.

40. A method as claimed in claim 29, wherein a quantity of filiform nanoparticles between 0.5% and 5% by volume is used.
